(19) United States
(12) Patent Application Publication
(10) Pub. No.: US 2018/0363641 A1
(43) Pub. Date: Dec. 20, 2018

(54) Reciprocating Compressor Monitoring System With Local Power Generation

(71) Applicant: Windrock, Inc., Knoxville, TN (US)

(72) Inventors: Steve Follmar, Houston, TX (US); Glenn Mincher, Houston, TX (US); R. Bryan Stewart, Houston, TX (US); Ferdinand G. Oliva, Houston, TX (US); Thomas E. Greene, JR., Morristown, TN (US)

(21) Appl. No.: 16/008,592

(22) Filed: Jun. 14, 2018

Related U.S. Application Data
(63) Continuation-in-part of application No. 15/835,687, filed on Dec. 8, 2017.
(60) Provisional application No. 62/531,194, filed on Jul. 11, 2017.
(60) Provisional application No. 62/432,291, filed on Dec. 9, 2016.

(51) Int. Cl. F04B 51/00; F04B 37/12; G01M 99/00; H02K 35/02

(52) U.S. Cl. CPC F04B 51/00; F04B 37/12; H02M 7/06; H02K 35/02; G01M 99/004

(57) ABSTRACT

A system for monitoring operation of a reciprocating compressor includes an inductive power generator configured such that reciprocating motion of a component of the compressor causes at least one magnet to move with respect to at least one coil and thereby inductively generate electrical power and one or more sensors powered by reciprocating motion of the compressor for monitoring a condition of the reciprocating compressor.

### CROSS-REFERENCES TO RELATED APPLICATIONS

This application claims priority to and is a non-provisional application of U.S. Provisional Patent Application Ser. No. 62/531,194 for a “Reciprocating Compressor Monitoring System With Local Power Generation” filed on Jul. 11, 2017, and claims priority to and is a continuation in part of U.S. patent application Ser. No. 15/835,687 for a “Reciprocating Compressor Monitoring System” filed on Dec. 8, 2017, which claims priority to and is a non-provisional application of U.S. Provisional Patent Application Ser. No. 62/432,291 for a “Reciprocating Compressor Monitoring System” filed on Dec. 9, 2016, the contents of which are incorporated herein by reference in their entireties.

### FIELD

The present application relates to the wireless self-powered condition monitoring of reciprocating compressors, and more particular, to an electric energy harvesting apparatus that can internally determine Top Dead Center (TDC) and encode various shaft angel positions and provide at least a portion of power needed to monitor pressure, vibration, and temperature, and to further wirelessly transmit the data to a receiver.

### BACKGROUND

FIG. 1 illustrates a natural gas transmission and distribution system 100. Raw natural gas is produced from a well 101 and piped via a gathering pipeline system 111 to gas processing plant 102, where it is purified and fractionated. The purified natural gas may be stored at storage facility 104 or provided to a transmission pipeline system 103. Transmission pipelines 112 may run thousands of miles and may be interstate or intrastate. End consumers, such as electric power plants 108 and some industrial 107 and commercial 110 consumers, that use large amounts of gas, may obtain gas directly from the transmission pipeline system. Other consumers, such as residential consumers 109 and some industrial 107 and commercial 110 consumers, obtain their gas from distribution pipeline 105.

To ensure that pressure is maintained within natural gas pipelines, compressor stations are placed at about 50 to 100 mile intervals along the gas pipelines. The compressor stations include one or more compressors, equipment for powering, operating, and cooling the compressors, as well as other equipment for conditioning and handling the gas. The compressors are generally either centrifugal compressors (which are not considered in this disclosure) or reciprocating compressors.

FIG. 2 shows a simplified illustration of a reciprocating compressor 200, a prime mover 201 for powering the compressor 200, and a control panel for monitoring and operating the compressor 200. Note that many components of each are not illustrated, in the interest of clarity. The prime mover 201 is typically an electric motor or a Natural Gas fueled internal combustion engine and serves to turn the crankshaft 205. The crankshaft 205 is housed within the crankcase 203. The illustrated compressor 200 includes four cylinders 204, but a compressor may have more or fewer cylinders. The crankcase houses a crankshaft 205. Each compressor throw 204 includes three sections—a compressor cylinder 206 (having a crank-end head, a cylinder body, and a head-end head), a section referred to as a distance piece 208, and a crosshead guide 209. The compressor cylinder 206 houses a piston 207. The crosshead guide 209 houses a crosshead 210. The distance piece 208 bridges the compressor cylinder 206 and the crosshead guide 209. The crosshead 210 connects a connecting rod 211 and a piston rod 212.

During operation, the prime mover 201 rotates the crankshaft 205. Rotation is typically on the order of 250-1800 rpm. Rotation of the crankshaft 205 causes the piston 207 to move outwardly (referred to as the “compression stroke”) and inwardly (referred to as the “tension stroke”). The movement of the piston 207 moves gas from the inlet 220 to the outlet 221. Each cylinder includes suction valves 222 and discharge valves 223 to keep the gas moving in the correct direction. The gas pressure is higher at the outlet 221 than at the inlet 220. The compressor 200 is referred to as a “double-acting” design because compression occurs on both sides of each piston 207. In other words, compression occurs on both the compression stroke and on the tension stroke.

A reciprocating compressor, as illustrated in FIG. 2, has many moving parts and is subject to a substantial amount of vibration and tensions. The compressor is typically run twenty-four hours per day, seven days per week. Those factors contribute to wear and tear on components of the compressor. Compressor operators monitor a variety of operating parameters of their compressors to identify abnormalities that may indicate the need for maintenance or may indicate impending catastrophic failure. Several monitoring points are illustrated on cylinder 204b. Points indicated with the letter “T” are points where temperature is routinely monitored, for example, at the inlet 220 and the outlet 221. Points indicated with a letter “P” are points where pressure is measured. Points indicated with a letter “V” are points where vibration is commonly measured. The measurements can be correlated with the rotational position of the crankshaft, and thus the position of the pistons within the cylinders, to provide indications of the health of the compressor. The ellipse containing the letters TDC indicate a sensor at the flywheel of the compressor, which measures the position of the crankshaft, allowing determination of top dead center (TDC) at each cylinder.

Typically, a compressor can be equipped with a monitoring system that includes an array of sensors permanently attached to the compressor and configured to constantly monitor the performance of the compressor. Such a system is illustrated in FIG. 3, where the T, P, V, and TDC indicate sensors for measuring temperature, pressure, vibration, and top dead center, respectively. Data from each of the sensors can be communicated to a computer for processing and/or storage. Some systems are capable of periodically transmitting the collected data to a remote location, via the internet or another network, for example.

The bold lines in FIG. 3 represent power and data cables. Such cables are typically contained within conduit and fixtures that must be secured to the compressor frame. The cabling, conduit, and fixtures impedes access to the compressor and must be disassembled to perform routine maintenance. The system of FIG. 3 illustrates an attempt to minimize the cabling and conduit using local hubs H at each of the cylinders of the compressor rather than individual power and signal cabling connecting each of the sensors individually to the control panel 202. However, even the central hubs require significant power and cabling. For example, the system requires power and signal cabling 301 connecting each of the hubs to the control panel 202. The system also requires power and signal cabling connecting the TDC sensor to the control panel 202 and signal cabling connecting the TDC sensor to each of the hubs, as explained in more detail below. Another disadvantage of a system as described above is that during initial installation the unit must be shut-down to 1) install a custom designed bracket to hold the TDC sensor and 2) run conduit and wires around the compressor to distribute power. TDC and data wires to each hub requires drilling of holes to mount brackets to hold the conduit. Cutting and bending the conduit and pulling wires to each hub requires substantial downtime, which is a significant disadvantage to the operator of the compressor in lost production.

Harvesting energy from machine movements is described, for example, by Zehnle in U.S. Pat. No. 9,431,877, Concentric Ring Generators. Mallapalli in U.S. Pat. No. 9,940,223, Method for Monitoring Linear Compressor, describes the use of electromagnetic induction to establishing that a piston is crashing.

The above and other prior art do not address specific measurements and power generation for reciprocating compressors in remote locations. Thus, there is a need in the art for a compressor monitoring systems that can operate on a continuous or semi-continuous basis without extensive power and data cabling, conduit, and fixtures and that can be installed while the unit is running.

### SUMMARY

The above and other needs are met by a system for monitoring operation of a reciprocating compressor. In a first aspect, a system for monitoring operation of a reciprocating compressor includes: an inductive power generator configured such that cyclic motion of a component of the compressor causes at least one magnet to move with respect to at least one coil and thereby inductively generate electrical power and one or more sensors powered by cyclic motion of the compressor for monitoring a condition of the reciprocating compressor.

In one embodiment, the system for monitoring operation of the reciprocating compressor further includes a generator rotor coupled to a shaft of the compressor, the generator rotor including one or more permanent magnets.

In another embodiment, the system for monitoring operation of the reciprocating compressor further includes one or more stationary magnetic pickups located in proximity to the generator rotor, wherein movement of the generator rotor in relation to the stationary magnetic pickups generates electrical power for the one or more sensors. In yet another embodiment, a top dead center (TDC) position of the reciprocating compressor is measured based on a magnet located on the generator rotor.

In one embodiment, a device powered by cyclic motion of the compressor monitor conditions selected from the group consisting of: top dead center detection, encoder angle of rotation measurement, cylinder head end pressure measurement, crank end pressure measurement, suction temperature measurement, additional cylinder temperature measurement, crosshead vibration measurement, monitor controller operation, and wireless communication with a monitor.

In a second aspect, a system for monitoring operation of a reciprocating compressor including an inductive power generator coupled to a shaft of the reciprocating compressor and one or more sensors in electrical communication with the inductive power generator for powering the one or more sensors, wherein sensors powered by reciprocal motion of the compressor monitor conditions selected from the group consisting of: top dead center detection, encoder angle of rotation measurement, cylinder head end pressure measurement, crank end pressure measurement, suction temperature measurement, additional cylinder temperature measurement, crosshead vibration measurement, monitor controller operation, and wireless communication with a monitor.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a gas distribution system according to one embodiment of the present disclosure;

FIG. 2 shows a reciprocating compressor according to one embodiment of the present disclosure;

FIG. 3 shows a prior art system for monitoring a reciprocating compressor;

FIG. 4 shows a wireless system for monitoring a reciprocating compressor according to one embodiment of the present disclosure;

FIG. 5 illustrates a cylinder having a power module for harvesting electrical power from the motion of a piston according to one embodiment of the present disclosure;

FIG. 6 shows a Faraday tube for harvesting electrical power from the motion of a piston according to one embodiment of the present disclosure;

FIG. 7 shows components of a power module according to one embodiment of the present disclosure;

FIG. 8 shows an algorithm for determining top dead center (TDC) of a cylinder from signals generated by a power module according to one embodiment of the present disclosure;

FIG. 9 shows components of a cylinder data acquisition controller (CDAC) according to one embodiment of the present disclosure;

FIG. 10 shows a system for monitoring a reciprocating compressor according to one embodiment of the present disclosure;

FIG. 11 shows a generator/encoder (GenEnc) according to one embodiment of the present disclosure;

FIG. 12 shows components of a cylinder data acquisition controller (CDAC) according to one embodiment of the present disclosure;

FIG. 13 shows an inductive generator according to one embodiment of the present disclosure;

FIG. 14 a circuit diagram of an inductive generator according to one embodiment of the present disclosure; and

FIG. 15 shows a diagram of a monitoring system according to one embodiment of the present disclosure.

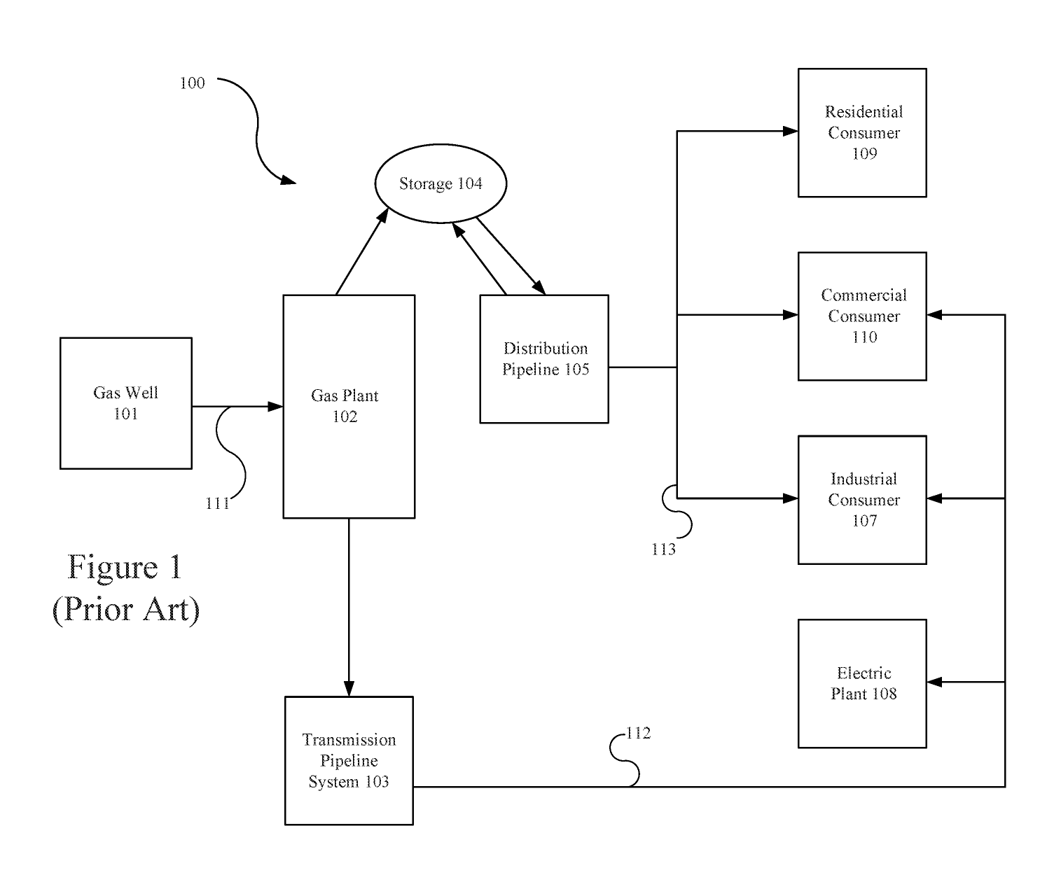

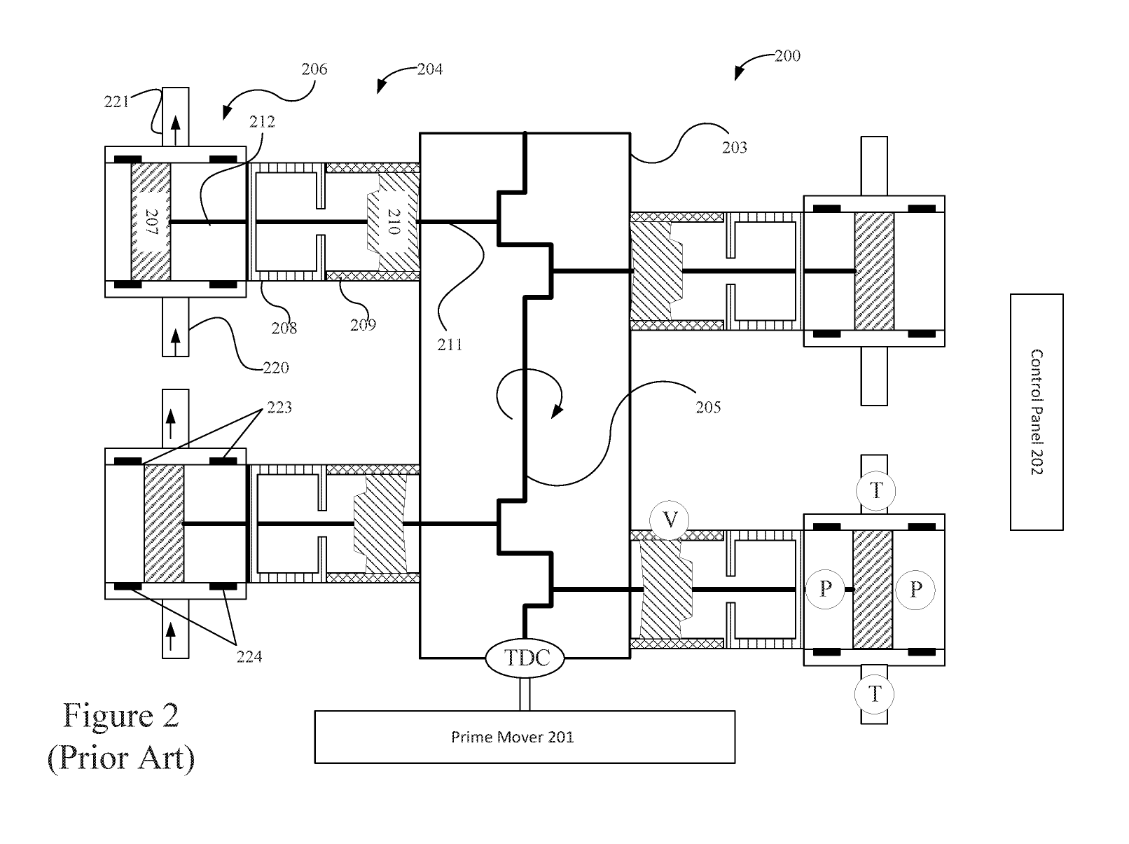

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

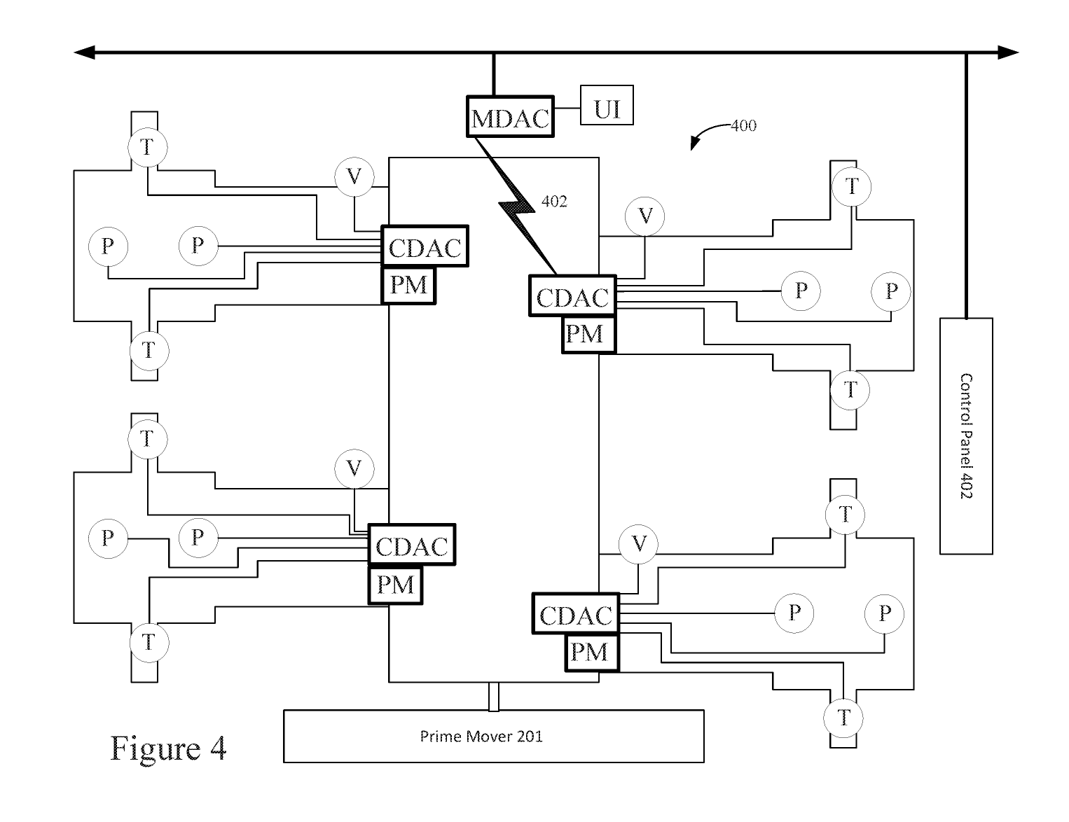

FIG. 4 illustrates one embodiment of a compressor monitoring system 400 that does not require the extensive cabling, conduit, and fixtures required by the prior art systems. The system 400 includes sensors for vibration, pressure, and temperature denoted V, P, and T, respectively. The system also includes local hubs, referred to herein as cylinder data acquisition controllers (CDACs) on each cylinder. CDACs are discussed in more detail below, but here it should be mentioned that, as used herein, the term CDAC refers to any hub located with respect to a cylinder configured to receive data from one or more sensors and/or electric power generators on that cylinder. The CDACs communicate with a central hub, referred to as a machine data acquisition controller (MDAC) via a wireless connection 402 between the CDAC and the MDAC. The MDAC may be associated with a user interface UI and/or a control panel 402.

Embodiments of the compressor monitoring system includes electric power modules PMs at each of the cylinders, which generate power for the monitoring components at that cylinder. Note that the electric power modules PMs and the CDACs are illustrated as being separate components. However, they may be combined within a single component and may even be combined upon a single circuit board. Moreover, process that are described herein as occurring at the power module PM may occur at the CDAC, and vice versa.

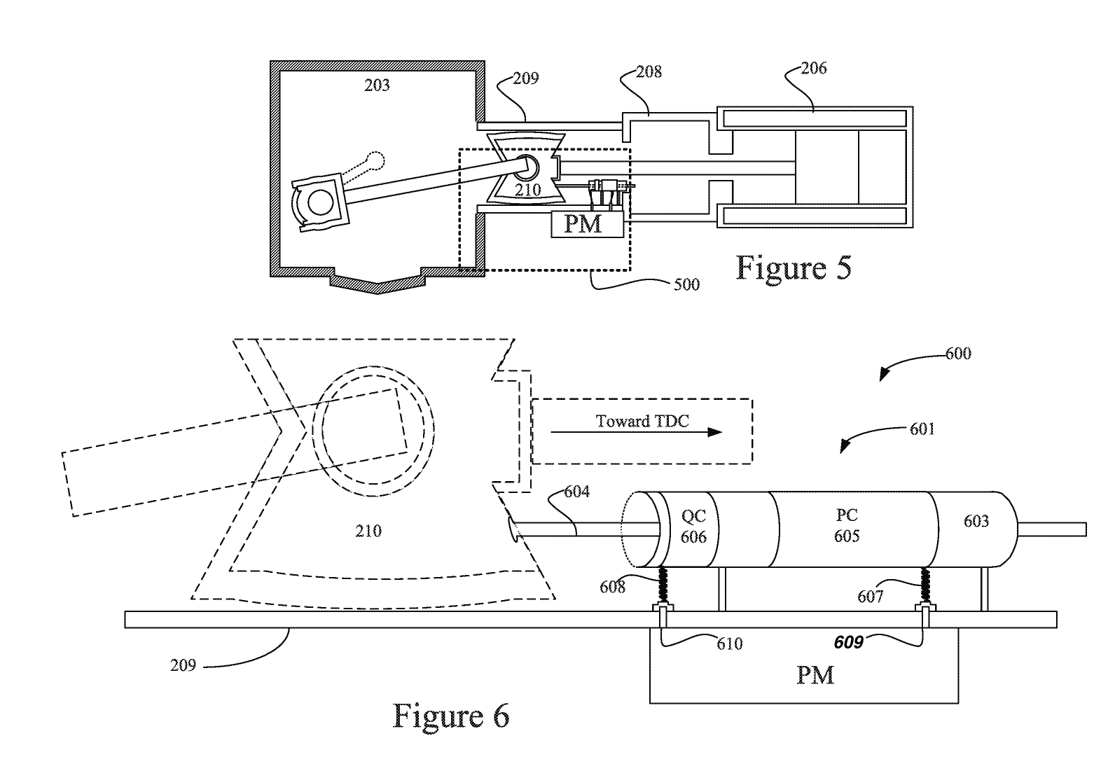

FIG. 5 illustrates is a cross-section view of a crank case 203 and the crosshead guide 209, distance piece 208, and compressor cylinder 206 of a single a cylinder 204. The cylinder is equipped with an electric power generator (enclosed in the dashed box 500), aka, power generating unit or power generation module.

The region of FIG. 5 enclosed in the dashed box 500 is expanded in FIG. 6. In FIG. 6, the connecting rod 211, piston rod 212, and crosshead 210 are illustrated in dotted lines to provide context. The illustrated electric power generator 600 comprises a Faraday tube 601 mounted inside the crosshead guide 209 and optionally, a power module PM, which may be mounted inside or outside the crosshead guide.

The Faraday tube 601 is an inductive power generating unit that includes a magnet that reciprocates inside a cylinder 603. The magnet may be mounted to a rod 604 attached to the crosshead 210 or the rod 604 itself may be magnetic. According to some embodiments, the magnet is a rare earth magnet, such as a neodymium-based magnet, mounted to the rod 604. The cylinder 603 may comprise any material that is sufficiently durable to withstand conditions within the crosshead guide 209. Examples include laminate materials comprising aramid polymers such as KEVLAR®, PVC, and/or any non-ferrous metal. The cylinder can be from about 6 to about 24 inches in length and is typically about 1 to about 3 inches in diameter.

Two coils, 605 and 606, are wound upon the cylinder 603. As the magnet connected to the rod 604 reciprocates within the coils 605 and 606, the oscillating magnetic field induces an AC current in the coils. The AC current induced in coil 605 is rectified and filtered to provide the power for the monitoring components present on the cylinder 204 and to provide a signal for determining TDC. Coil 605 is referred to as the power coil, or PC. Logic/circuitry (described in greater detail below) uses the induced voltage across the coil 606 to determine the direction the piston is moving. Coil 606 is referred to as the qualifier coil, or QC. Conductors, such as a twisted pairs of wires 607 and 608 connect the coils to the power module PM via feedthroughs 609 and 610, respectively.

Before describing the power module PM, it should be reiterated that the power generated using the Faraday tube 601 serves two purposes: 1) to power the monitoring components on each cylinder, and 2) to allow determination of the piston with the cylinder (e.g., TDC) for each of the cylinders. The ability to perform those functions locally at each cylinder alleviate the need for conduit and cabling.

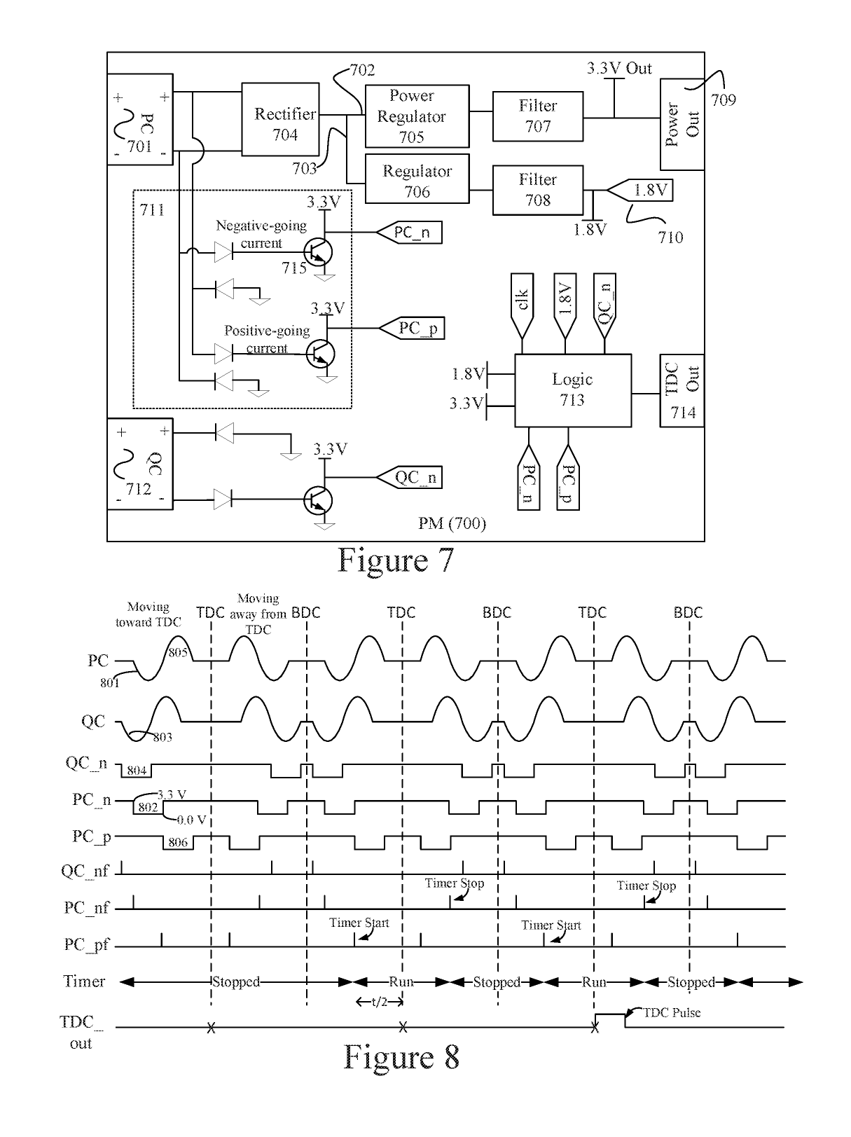

FIG. 7 illustrates the logical components of the power module PM (700). Note that many electronic elements are omitted from FIG. 7, in the interest of clarity. Also note that elements of PM 700 and of CDAC 900 (described below) are executed using circuitry and/or logic, which may be embodied as microprocessors, microcontrollers, digital logic, analog circuitry, and the like, as is known to a person of skill in the art. For example, types of circuitry may include microprocessors, FPGAs, DSPs, or combinations of these, etc. Circuitry may also be formed in whole or in part in one or more Application Specific Integrated Circuits (ASICs). Elements may be embodied in hardware, firmware, and/or software, as will be apparent to a person of skill in the art. Circuitry may be referred to herein variously as circuitry and/or logic, depending on context.

Referring again to FIG. 7, the positive (+) and negative (−) ends of the power coil PC (FIG. 6, 605) are provided to an input jack 701. AC current and voltage generated by the coil is rectified using a rectifier 704 to provide a DC current and voltage. In the illustrated embodiment, the DC current is supplied to two power regulators to provide regulated voltages. Specifically, the DC current is provided to (1) a high power regulator 705 to supply power for the power output jack 709 and to supply a 3.3 V power source for operating the electronic components of the power module PM itself. The DC current from the rectifier 704 is also supplied to (2) a low power regulator to provide a 1.8 V TDC signal 710 and to provide a low voltage (1.8 V) rail for components of the power module PM 700. Note that 3.3 V and 1.8 V are design considerations; other values may be used. The high voltage is output to a power out jack 709, which can be connected to the monitoring components via the CDAC on each cylinder (see FIG. 4).

The AC current from the power coil PC is also supplied to a split-full-wave rectifier 711 to supply input signals to the logic used to determine TDC of the cylinder. The split-full-wave rectifier 711 is divided into two sections: (1) a negative-going current section that generates a signal (PC_n) when the AC current swings negative, and (2) a positive-going current section that generates a signal (PC_p) when the AC current swings positive.

The power module PM 700 also includes an input jack 712 that is connected to the positive (+) and negative (−) ends of the qualifier coil QC 606 (see FIG. 6). The AC current from the qualifier coil QC is rectified to provide a signal (QC_n) that indicates when the QC AC current swings negative.

The negative-going and positive-going PC signals PC_n and PC_P, respectively, along with the negative-going QC signal QC_n, are provided to a logic module 713, which is configured to generated a signal indicating TDC of the cylinder. The logic module 713 may be implemented as discrete logic blocks, a microprocessor, a programmable logic array (PLA), a generic array logic (GAL), a field programmable gate array (FPGA), a complex programmable logic device (CPLD), or any other logic component or combination of logic components known in the art. An example of a suitable CPLD is an Altera Max 7000-series platform, available from Altera Corporation, San Jose, Calif. The logic module 713 uses the PC and QC signals, along with one or more timing signals clk, to generate a TDC signal, which is outputted to the CDAC (FIG. 4) via a TDC output jack 714.

FIG. 8 illustrates an example algorithm the logic module 713 can use to generate the TDC signal for a given cylinder. The top line PC, illustrates the AC signal (i.e., AC current) that the power coil generates as it moves toward TDC and away from TDC (i.e., toward bottom dead center BDC). TDC and BDC are illustrated with dotted lines for three cycles of the cylinder. As the AC signal of the power coil PC swings negative 801, the PC_n signal falls from 3.3 V to 0. Referring back to FIG. 7, the voltage drops because the negative-going current from the power coil turns on the transistor 715, grounding the 3.3 V collector voltage. Likewise, the negative-going current of the qualification coil QC 803 causes a drop 804 in the QC_n signal. The positive-going power coil PC current causes a drop 806 in the PC_n signal.

The pulses QC_nf, PC_nf, and PC_pf correspond to the falling edges of the signals QC_n, PC_n, and PC_p, respectively. The falling-edge pulses are used to control a timer. In the illustrated algorithm, the timer remains stopped until a requisite number of QC_nf pulses are detected. The requisite number of QC_nf pulses is three in the illustrated algorithm. Holding for the requisite number of QC_nf pulses insures that the piston is moving toward TDC and not away from it. The PC_pf pulse immediately following the final of the requisite number of QC_nf triggers the timer. The immediately following PC_nf pulse stops the timer. Dividing the number of counts between PC_pf and QC_nf yields the number of counts to reach TDC (t/2). The t/2 value is stored in memory. The following PC_pf pulse starts the clock. When the clock reaches t/2 counts (stored in memory), the logic asserts the TDC pulse, which is delivered to the CDAC via TDC Out 714.

The algorithm illustrated in FIG. 8 is only one of many algorithms that may be used to determine TDC. An alternative algorithm uses multiple magnets mounted on the crosshead or other linear moving component. The magnets pass a stationary coil (a magnetic pickup or other inductive device) such that each magnet produces a current/voltage as it passes the coil. That voltage can be rectified, filtered, & regulated to create a DC voltage that can be used to power the system (or parts of the system). The magnets can be in a single line so that a single pickup senses their passing. An embodiment of a TDC algorithm compatible with having multiple magnets in a single line and a single pickup entails sensing the last of the series of events as the line of magnets approaches TDC, and the first of the series of events as the line of magnets recedes from TDC. Half of that time difference corresponds to TDC.

A still further embodiment for determining TDC involves measuring a single event occurs when a magnet mounted on the reciprocating assembly induces a voltage in a stationary coil or pickup. The coil/pickup is mounted so that the resulting voltage event occurs closer to TDC than BDC. The logic measures the times between voltage events when the piston approaches TDC and for BDC as well. The logic then uses the lesser of both recorded times for the (t/2) calculation. Further, once the cycle having the lesser value occurs and is identified, the logic will synchronize so that cycle is active before enabling the timer. Both the value comparison and the cycle identification decisions are performed on each compressor cycle to ensure that the system is always properly synchronized to the correct cycle.

Alternately, a combination of one or more magnets and sensing elements can be arranged to implement the TDC algorithm described previously. The magnet arrangement may include several geometries and mounting arrangements, including but not limited to several concentric ring magnets, solid cylinder, or cube magnets. The concept is to produce a unique magnetic event or event sequence that occurs at the same point in the reciprocating cycle, both approaching TDC and receding from TDC. This unique event is used by the timer hardware/software to determine position of TDC.

A person of skill in the art can derive many different ways of determining TDC from the positive-going and negative-going current from the power coil, combined with a qualifier signal to discriminate between motion toward and away from TDC, to a microcontroller with external or embedded software. In addition, other qualifiers such as time differentials with offset sensors, etc. might be used as well.

Sensing elements can be, but are not limited to, magnetic pickups using the principle of magnetic induction to produce a voltage and current. This arrangement can also be used to generate system power. Power generation is accomplished by the arrangement of the concentric ring, cylinder, or cube magnets in such a manner as to optimize the induced voltage/current in the pickup. This arrangement may consist of mounting alternating polarity concentric ring (or other) magnets in close proximity so that their overlapping fields are additive as they pass the sensing device, resulting in a higher induced voltage, thus maximizing output power.

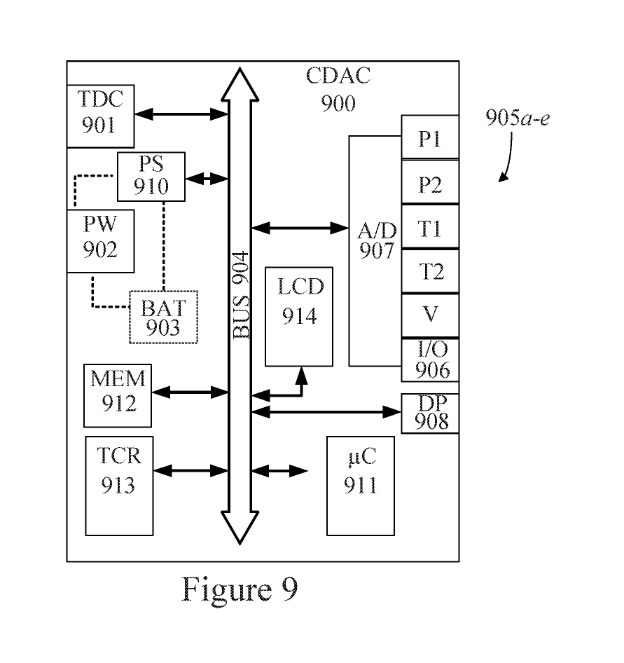

FIG. 9 illustrates an embodiment of a CDAC 900. CDAC 900 includes ports 901 and 902 for receiving the TDC pulse and power, respectively, from the power module PM. CDAC 900 also includes a data bus 904. In FIG. 9, both analog and digital buses are combined and represented as a single data bus 904 for simplicity, though in practice multiple buses would be required. The TDC pulse may be supplied to the bus 904.

Power from the power port 902 can be provided to a power supply module PS 910 to provide various required voltages for operating CDAC 900. The power supply module 910 may communicate with a data bus 904. According to some embodiments, power received via port 902 can be stored, for example, by charging a battery 903 or a super capacitor. Charge storage is not necessary according to other embodiments.

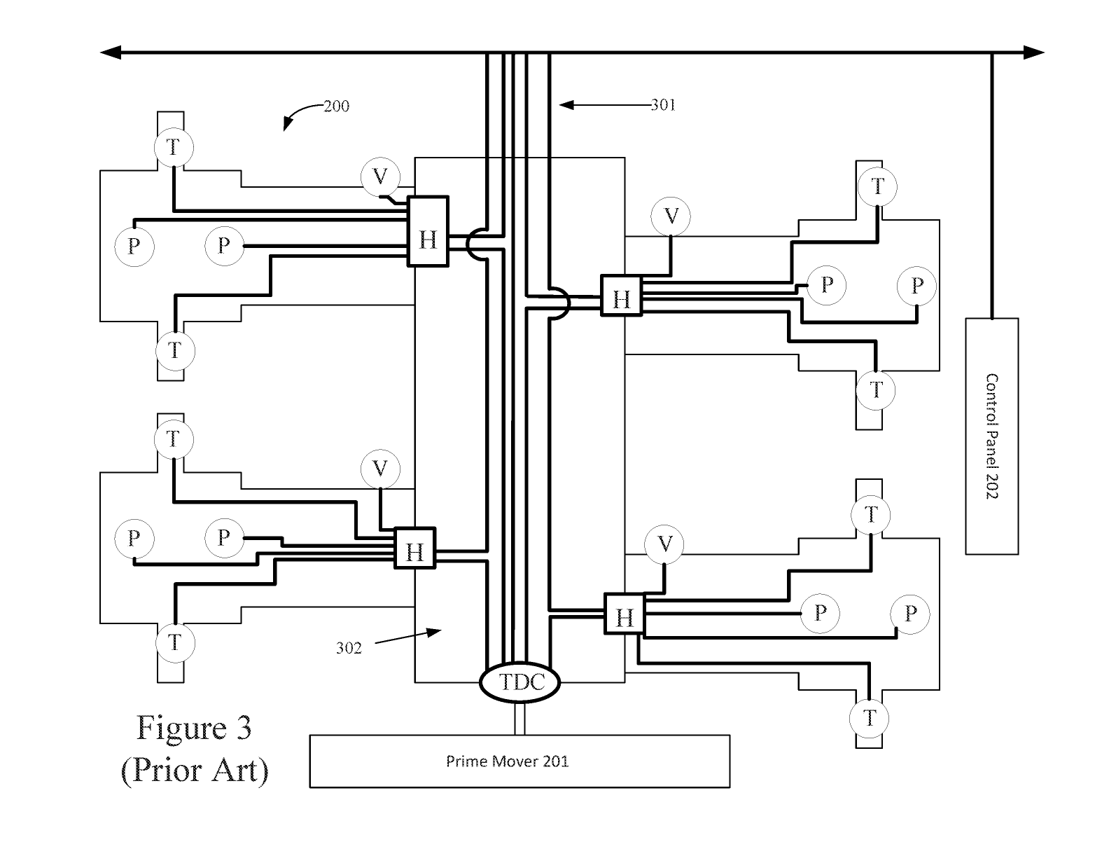

CDAC 900 includes a series of ports 905a-e for receiving signals from pressure (P), temperature (T), and vibration sensors (V), such as the sensors illustrated in FIG. 3. CDAC 900 may include one or more additional ports, for example, I/O port 906 for connecting to other equipment, such as test equipment, additional sensors, and like. According to some embodiments, the signals from the ports 905a-e and 906 are converted to digital signals by one or more analog-to-digital (A/D) converters 907. Data from the A/D converter 907 can be communicated to the bus 904. CDAC 900 may also include one or more digital ports DP 908, which may communicate with the bus 904.

CDAC 900 includes a microcontroller μC 911, which may generally be a microprocessor. Examples of suitable microcontrollers include low power (e.g. nano-watt) USB microcontroller. A specific example is a PIC18F46J50 from Microchip, Inc. The microcontroller 911 is configured to receive the digital signals from the bus and condition those signals and condition those signals for processing at the MDAC (FIG. 4). The microcontroller 911 may be programmed to perform one or more conditioning functions, including amplification, filtering, converting, range matching, isolation, or the like. For example, the vibration signal may be converted by use of either a peak-hold or an envelope detection circuit before the signal is converted into digital data and sent to the microcontroller. Alternatively, the same function(s) could be performed within the microcontroller using digital signal processing (DSP) techniques well known by someone skilled in the art. Integrating the vibration envelope which yields a velocity signal since integrating acceleration (the accelerometer vibration signal) gives velocity. This integration function can also be performed by the microcontroller using DSP techniques. The microcontroller 911 can also format the resulting digital data in a format expected by processing software at the MDAC and can also package the data in a protocol appropriate for wireless transmission to the MDAC.

CDAC 900 may also include one or more memories 912. Examples of memory may include read-only memory, such as EEPROM or other non-volatile memory. CDAC 900 may also include volatile memory, for example, DRAM, SRAM, or the like. Data from the A/D converter 907 and/or the microcontroller 911 may be stored in volatile memory, for example.

CDAC 900 also includes a wireless transceiver TCR 913. The wireless transceiver 913 may operate in an industrial, scientific, and medical (ISM) radio band, for example. The wireless transceiver 913 may implement a spread spectrum, or other frequency hopping methodology, to allow low power output while maintaining transmission integrity. The CDAC 900 may also include a display, such as an LCD display 914, for displaying basic parameters such as rpms, power supply levels, and the like, which the display 914 may obtain from the bus 904. An aspect of embodiments of the CDAC 900 is its low power consumption and its ability to interface with very low powered sensors. The pressure, vibration, and temperature transducers traditionally used to monitor compressors typically operate on a 4-20 mA current loop and require 9-24 V voltage excitation source to operate them. Examples of such sensors include resistance temperature detectors (RTDs) and thermocouples for sensing temperature, 4-20 mA output strain sensors for measuring pressure, and accelerometers for measuring vibration. While such sensors can be used with embodiments of the presently disclosed methods and systems, it is generally preferable to use lower powered sensors. According to some embodiments, the CDAC 900 interfaces with pressure, vibration, and temperature sensors that generate about 1 to about

3.3. V as inputs to the CDAC 900. For example, the disclosed system may use a thermistor for detecting temperature, instead of a thermocouple or RTD detector. A low-voltage strain gauge or piezo resistive transducer can be used to measure pressure. Examples of suitable vibration sensors include microelectromechanical (MEMS) based accelerometers/vibration sensors. Examples include the ADXL001 iMEMs High Performance Wide Bandwidth Accelerometer from Analog Devices, Inc. (Norwood, Mass.).

Referring again to FIG. 4, the CDAC on each cylinder can wirelessly transmit the conditioned sensor data received from the sensors on that cylinder to the MDAC. According to some embodiments, the sensor data is phased with relation to the piston position in the cylinder (relative to TDC, for example). In other words, pressure, temperature, and accelerometer data for every degree of rotation may be transmitted. This allows plotting pressure v time or pressure v volume, throughout the cycle, generating a closed curve, which can then be integrated to generate the actual power being consumed by the cylinder. Thus, exemplary embodiments generate complete dynamic cycle waveforms of pressure and vibration that are phased to rod motion. According to some embodiments, the phased sensor data from a cylinder can contain one or more complete cycles of the cylinder from one TDC pulse to another.

The MDAC can be essentially any computing device, such as a desktop-type computer or a programmable logic controller (PLC). The MDAC collects data from each of the CDACs, checks that the data is within expected parameters, and stores the collected data on a memory. The MDAC can have a network connection, such as an Ethernet connection, which can provide for remote monitoring of the compressor's condition. The MDAC may be programmed to activate an alarm or initiate remedial actions if the received parameters are outside of expected ranges. According to some embodiments, the MDAC is based on a Linux operating system. For instance, the MDAC will have the capability to perform standard industry calculations like IHP, Load Calculations, Flow Calculations, Rod Loads, Load Reversal and Theoretical Cylinder End Clearances. The MDAC will also contain logic in the form of a rule-based program that diagnoses common compressor malfunctions like Suction and Discharge Valve Leakage, Piston Ring Leakage, Packing Leakage, Rod Reversal problems, improper operation of unloaders, and excessive Load conditions among other detachable malfunctions. A new and unique feature of the Rule Based Expert module will be a “severity index” to determine when corrective action is indicated to correct the malfunction. The system will provide clear text messages to the operator when remedial action is required to correct a detected malfunction.

Considering the number of data points taken, many anomalies can be detected and flagged within the software, including compressor valve leakage, piston ring blow-by, packing leakage, mechanical looseness, and a number of other operating issues.

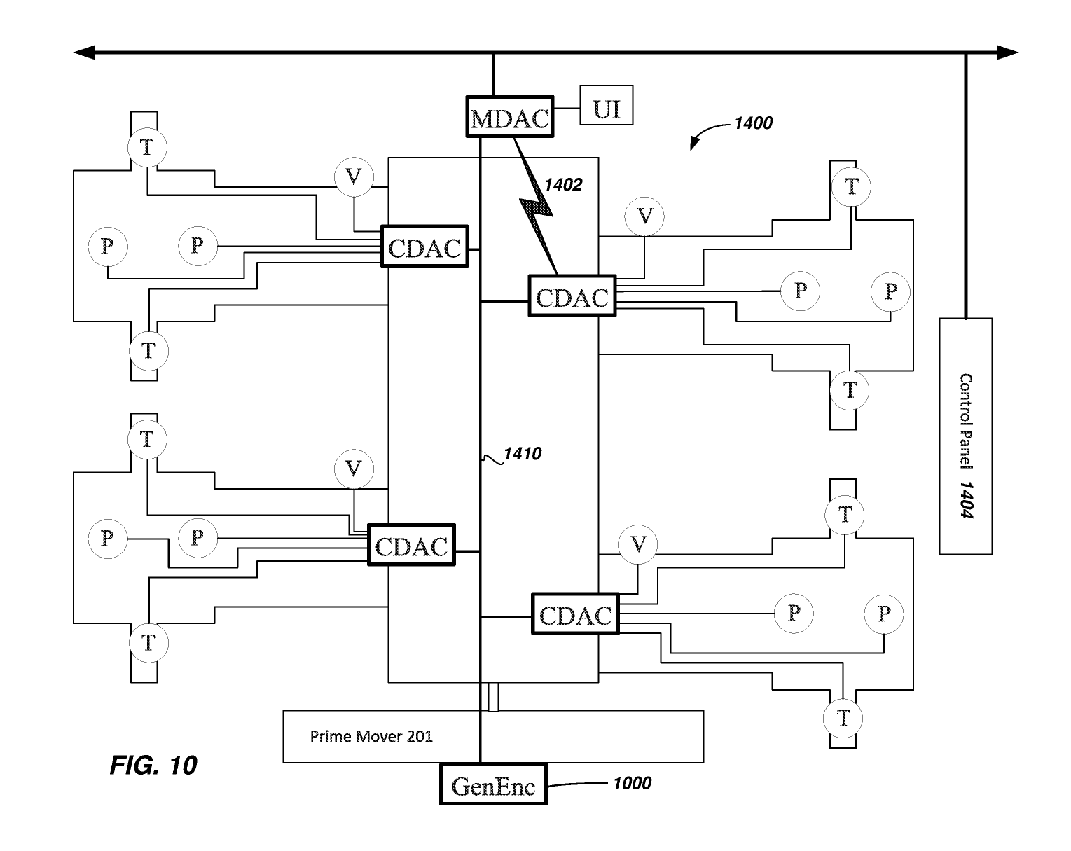

FIG. 10 illustrates another embodiment compressor monitoring system 1400 that does not require the extensive cabling, conduit, and fixtures required by the prior art systems. The system 1400 also includes sensors for vibration, pressure, and temperature denoted V, P, and T, respectively. The system also includes local hubs, including cylinder data acquisition controllers (CDACs) on each cylinder. The CDACs communicate with a central hub, shown as a machine data acquisition controller (MDAC) via a wireless connection 1402 between the CDAC and the MDAC. The MDAC may be associated with a user interface UI and/or a control panel 1404.

The inventors have recognized four factors that must be addressed to implement a wireless-based compressor monitoring system 1400. Those factors are: 1) generation of sufficient electric power close to each of the cylinders; 2) determination of TDC for each of the cylinders in a way that does not require the installation of a custom designed bracket; 3) minimizing electric power consumption by the monitoring components; and 4) a simplified wiring scheme. Each of those factors are discussed in more detail below.

Referring again to FIG. 10, the compressor monitoring system 1400 includes an electric power module 1000 (a.k.a. generator/encoder module, “GenEnc”) at one end of the compressor frame, which generates power for the monitoring components of every cylinder. The GenEnc 1000 may be a low-voltage generator, such as a 3.3 VDC rotary generator. An example of a suitable generator for the GenEnc module 1000 is a BLW23 series brushless DC motor, available from Anaheim Automation (Anaheim, Calif.).

The GenEnc 1000 may couple to a crank shaft of the compressor. According to one embodiment, the GenEnc 1000 couples to the flywheel of the compressor. Alternatively, the GenEnc 1000 may attach to the crank shaft via the encoder port of the compressor. As is known in the art, reciprocating compressors typically include an encoder port, whereby diagnostic equipment can be attached to the crank shaft of the compressor. The encoder port is typically only used for temporary attachment of an encoding device by compressor analysts and others. The GenEnc 1000 generates low voltage power from the rotation of the crank shaft.

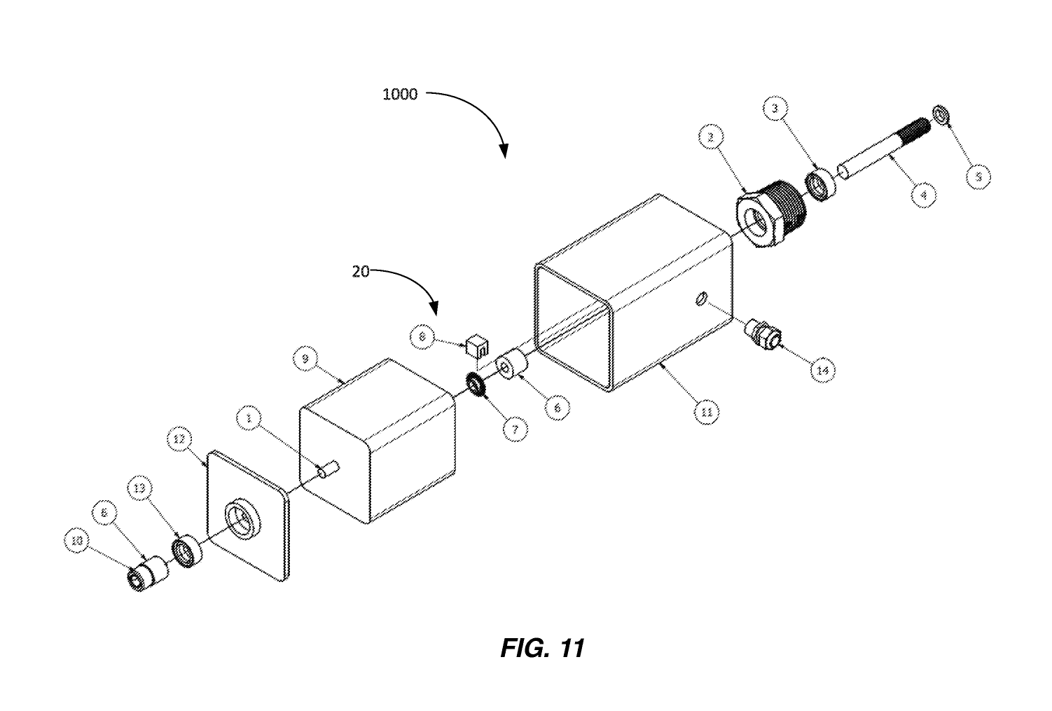

FIG. 11 illustrates an embodiment of the GenEnc 1000 configured to attach to a crank shaft of a compressor via the compressor's encoder port. The GenEnc 1000 connects to the crank shaft of the compressor via connection coupling 4 and alignment bushing 5. The coupling 4 may be a flexible coupling, such as a spider-type coupling or other flex coupling. The coupling 4 attaches to the crank shaft of the compressor via an appropriate attachment for the particular compressor, for example via a ⅜″ hex key. The connection between the GenEnc 1000 and the compressor may be via a standard NPT frame mount 2. Most compressor encoder ports are 1″ NPT or 1¼″ NPT. The coupling connection may also include an oil seal 3.

The GenEnc 1000 comprises a rotary generator 9, as described above, contained within housing 11. The housing 11 can be permanently attached to a pedestal mount for the compressor's encoder port, the pedestal mount having sufficient slotting to allow for proper alignment between the GenEnc 1000 and the compressor's crank shaft. The housing 11 may include one or more cable connectors 14 for supplying power and/or data signals from the GenEnc 1000.

The GenEnc may include an encoder module 20. The encoder module 20 may comprise a very low voltage encoder, either wired or wireless, of either an optical or electronic design, capable of providing a trigger point (usually TDC). The illustrated encoder module comprises an optical wheel 7 and optical sensor 8 for determining TDC. The encoder module 20 is attached to the connection coupling 4 via a flexible coupling shaft 6. An additional coupling shaft (not shown) can connect the encoder module 20 to the generator 9.

The generator 9 can include a generator shaft 1 that can be accessible through the lid 12 of the housing 11 via a connector 10 attached to the generator shaft 1 via a shaft coupling 6. The generator shaft 1 provides a secondary method of attaching an additional encoder, either mechanically, electronically, or wirelessly such that two separate trigger points can be acquired by two independent data acquisition systems. The generator shaft 1 also provides a fitting conducive to a secondary analyst connection such that concurrent analyses are possible using a secondary encoder or an electronic signal from our encoder. A dust/oil seal may be included between the connector 10 and the housing lid 12.

Referring again to FIG. 10, power generated by the GenEnc 1000 is delivered to the CDACs and/or the MDAC via cabling 1410. Cabling 1410 may be armored or shielded. This and other cabling can be secured to the compressor frame or other metallic embodiment via magnetically based cable tie downs of plastic (nylon) or other non-conductive binding material. TDC data can also be transmitted via cabling 1410.

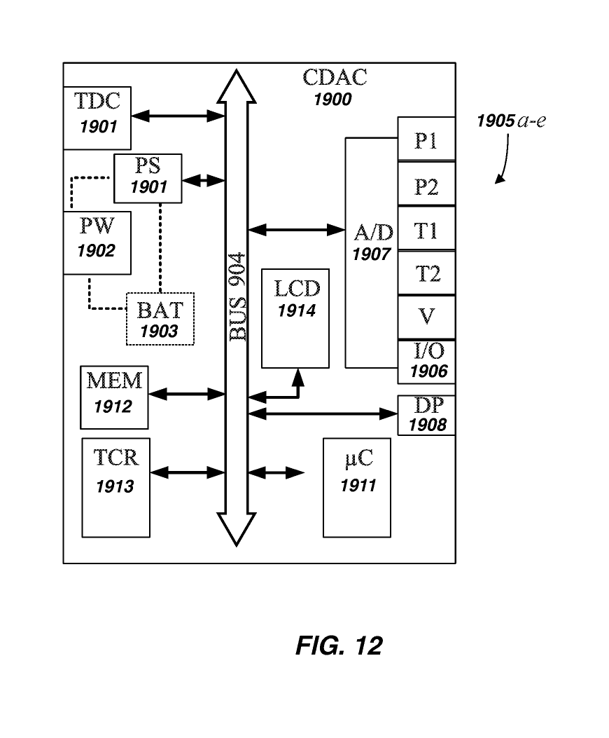

FIG. 12 illustrates another embodiment of a CDAC 1900. CDAC 1900 includes ports 1901 and 1902 for receiving the TDC pulse and power, respectively, from the GenEnc 1000. CDAC 900 also includes a data bus 1904. In FIG. 12, both analog and digital buses are combined and represented as a single data bus 1904 for simplicity, though in practice multiple buses would be required. The TDC pulse may be supplied to the bus 1904.

Power from the power port 1902 can be provided to a power supply module PS 1910 to provide various required voltages for operating CDAC 1900. The power supply module 1910 may communicate with a data bus 1904. According to some embodiments, power received via port 1902 can be stored, for example, by charging a battery 1903 or a super capacitor. Charge storage is not necessary according to other embodiments.

CDAC 1900 includes a series of ports 1905a-e for receiving signals from pressure (P), temperature (T), and vibration sensors (V), such as the sensors illustrated in FIG. 3. CDAC 1900 may include one or more additional ports, for example, I/O port 1906 for connecting to other equipment, such as test equipment, additional sensors, and like. According to some embodiments, the signals from the ports 1905a-e and 1906 are converted to digital signals by one or more analog-to-digital (A/D) converters 1907. Data from the A/D converter 1907 can be communicated to the bus 1904. CDAC 1900 may also include one or more digital ports DP 1908, which may communicate with the bus 1904.

CDAC 1900 includes a microcontroller μC 1911, which may generally be a microprocessor. Examples of suitable microcontrollers include low power (e.g. nano-watt) USB microcontroller. A specific example is a PIC18F46J50 from Microchip, Inc. The microcontroller 1911 is configured to receive the digital signals from the bus and condition those signals and condition those signals for processing at the MDAC (FIG. 10). The microcontroller 1911 may be programmed to perform one or more conditioning functions, including amplification, filtering, converting, range matching, isolation, or the like. For example, the vibration signal may be converted by use of either a peak-hold or an envelope detection circuit before the signal is converted into digital data and sent to the microcontroller. Alternatively, the same function(s) could be performed within the microcontroller using digital signal processing (DSP) techniques well known by someone skilled in the art. Integrating the vibration envelope which yields a velocity signal since integrating acceleration (the accelerometer vibration signal) gives velocity. This integration function can also be performed by the microcontroller using DSP techniques. The microcontroller 1911 can also format the resulting digital data in a format expected by processing software at the MDAC and can also package the data in a protocol appropriate for wireless transmission to the MDAC.

CDAC 1900 may also include one or more memories 1912. Examples of memory may include read-only memory, such as EEPROM or other non-volatile memory. CDAC 1900 may also include volatile memory, for example, DRAM, SRAM, or the like. Data from the A/D converter 1907 and/or the microcontroller 1911 may be stored in volatile memory, for example.

CDAC 1900 also includes a wireless transceiver TCR 913. The wireless transceiver 1913 may operate in an industrial, scientific, and medical (ISM) radio band, for example. The wireless transceiver 1913 may implement a spread spectrum, or other frequency hopping methodology, to allow low power output while maintaining transmission integrity. The CDAC 1900 may also include a display, such as an LCD display 1914, for displaying basic parameters such as rpms, power supply levels, and the like, which the display 1914 may obtain from the bus 1904.

An aspect of embodiments of the CDAC 1900 is its low power consumption and its ability to interface with very low powered sensors. The pressure, vibration, and temperature transducers traditionally used to monitor compressors typically operate on a 4-20 mA current loop and require 9-24 V voltage excitation source to operate them. Examples of such sensors include resistance temperature detectors (RTDs) and thermocouples for sensing temperature, 4-20 mA output strain sensors for measuring pressure, and accelerometers for measuring vibration. While such sensors can be used with embodiments of the presently disclosed methods and systems, it is generally preferable to use lower powered sensors. According to some embodiments, the CDAC 1900 interfaces with pressure, vibration, and temperature sensors that generate about 1 to about 3.3. V as inputs to the CDAC 1900. For example, the disclosed system may use a thermistor for detecting temperature, instead of a thermocouple or RTD detector. A low-voltage strain gauge or piezo resistive transducer can be used to measure pressure. Examples of suitable vibration sensors include microelectromechanical (MEMS) based accelerometers/vibration sensors. Examples include the ADXL001 iMEMs High Performance Wide Bandwidth Accelerometer from Analog Devices, Inc. (Norwood, Mass.).

Referring again to FIG. 10, the CDAC on each cylinder can wirelessly transmit the conditioned data received from the sensors on that cylinder to the MDAC. The MDAC can be essentially any computing device, such as a desktop-type computer or a programmable logic controller (PLC). The MDAC collects data from each of the CDACs, checks that the data is within expected parameters, and stores the collected data on a memory. The MDAC can have a network connection, such as an Ethernet connection, which can provide for remote monitoring of the compressor's condition. The MDAC may be programmed to activate an alarm or initiate remedial actions if the received parameters are outside of expected ranges. According to some embodiments, the MDAC is based on a Linux operating system. For instance, the MDAC will have the capability to perform standard industry calculations like IHP, Load Calculations, Flow Calculations, Rod Loads, Load Reversal and Theoretical Cylinder End Clearances. The MDAC will also contain logic in the form of a rule based program that diagnoses common compressor malfunctions like Suction and Discharge Valve Leakage, Piston Ring Leakage, Packing Leakage, Rod Reversal problems, improper operation of unloaders, and excessive Load conditions among other detachable malfunctions. A new and unique feature of the Rule Based Expert module will be a “severity index” to determine when corrective action is indicated to correct the malfunction. The system will provide clear text messages to the operator when remedial action is required to correct a detected malfunction.

Considering the number of data points taken, many anomalies can be detected and flagged within the software, including compressor valve leakage, piston ring blow-by, packing leakage, mechanical looseness, and a number of other operating issues.

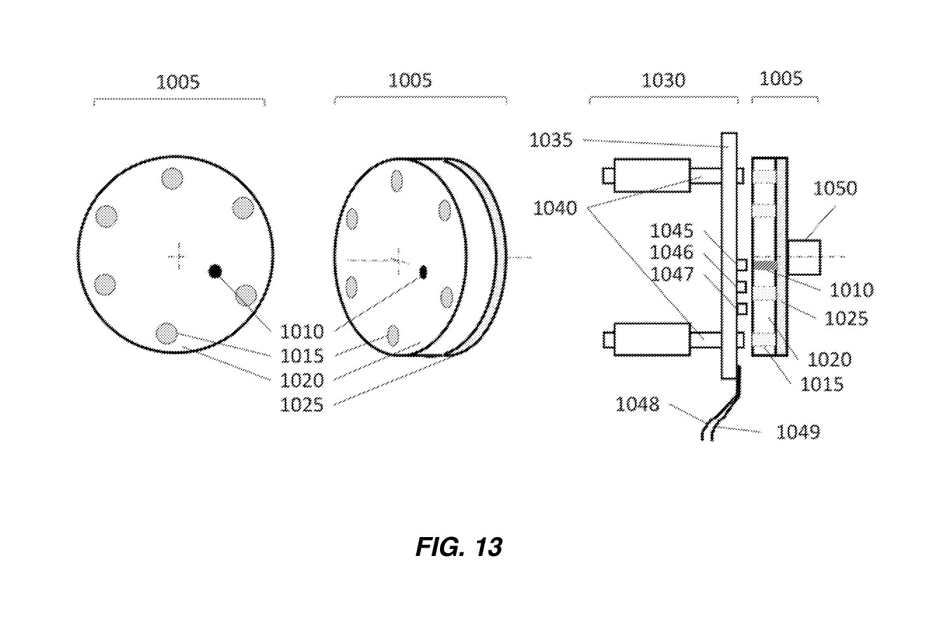

Referring now to FIG. 13, in another embodiment a generator harvests energy for a sensor using one or more mag pickups magnetically coupled with one or more moving permanent magnets. Energy harvesting is accomplished using a generator stator 1030 magnetically engaging a generator rotor 1005 having a rotor body 1020 that is driven by a shaft coupling such as a compressor shaft to generator rotor coupling 1050. Magnetic interaction may be axial gap or radial gap or by a combination of the two. FIG. 13 shows an exemplary axial gap arrangement.

The generator rotor 1005 may include one or more generator magnets 1015 positioned to move within proximity of one or more stator magnetic pickups 1040. Suitable stator magnetic pickups 1040 may be, for example, sold as Honeywell part number 3015A. An optional flux return path 1025 may be included to reduce eddy current losses, reduce heating, and to improve efficiency. The generator magnets 1015 are preferably mounted on or to a non-magnetic structural material such as polymer or aluminum.

With further reference to FIG. 13, a TDC sensor 1045 may be further included that is positioned to monitor a TDC magnet 1010. An exemplary TDC sensor is a magneto resistive detector 1045 such as Coto Technology RR110-A111-00, which advantageously consumers minimal power and operates down to zero speed with high and consistent signal performance. This supports an objective of delivering an output pulse with and amplitude independent of shaft speed down to zero RPM.

State of the art energy harvesting represented by Zehnle in U.S. Pat. No. 9,431,877 includes a generator with rotor and stator. Furthermore, state of the art inductive sensor exemplified by Mallampalli in U.S. Pat. No. 9,940,223 uses an inductive sensor to make a measurement. However, there is not any attempt to make use of the electrical power provided by the moving coil magnet configuration. Embodiments of the present invention advance the art by deriving synergy enabled by integrating machinery condition monitoring functionality such as sensory measurement, power management and data processing with inductive energy harvester functionality including shared functions, shared electronics, shared stationary and moving electromechanical components, shared signals from power, resistance, voltage and current. Embodiments disclosed herein scavenge energy and product electrical power from a reciprocating compressor. Typically, the compressor mechanism drives a cyclic motion of a magnet relative to a coil. Cyclic motion generates electrical power used by a condition monitoring device, and the condition monitoring device measures an operational characteristic of the compressor. A procedure of installing and operating the condition monitoring system is particularly helpful for installation on compressors after they are operational because installation is quick, non-invasive, efficient, and cost effective.

A generator stator typically comprises at least one mag pickup 1045, a circuit board 1035 including TDC detector 1045. The TDC detector 1045 is positioned in line with the moving TDC magnet 1015 and the mag pickup 1045 is positioned in line with rotor magnet(s) 1020.

Circuit board 1035 components include a microprocessor 1046 and a backup energy device such as a rechargeable or primary cell battery 1047. Circuit board 1035 is connected to a user input 1048 device that supports user selections among choices and settings such as 2 or 4 stroke settings, and further if 4 stroke then further selection of A phase or B phase are selectable by a user using an interface such as a switch, button, wired, or wireless input. The sensory output mechanism 1049 may comprise a wired or wireless linkage suitable for precise time domain data. An important advantage of this hybrid use of harvested power when operation and battery power when not operating is the ability to retain TDC phase for extended periods when the compressor is stopping, stopped, and restarting.

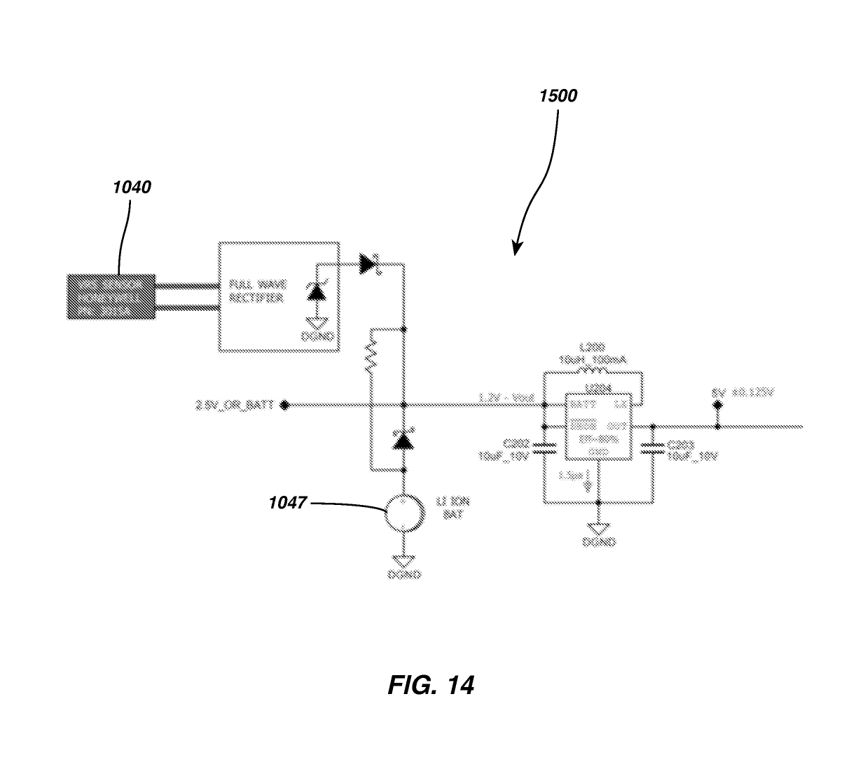

FIG. 14 an exemplary power generation circuit 1500 to derive electrical power from embodiments of harvested energy generators described herein. Mag pickup 1040, such as Honeywell part number 3015A, can be used as a TDC sensor in place of or in addition to other detection sensors such as sensor 1045. Mag pickup 1045 can be used as an electrical energy harvester. Rectified power from the harvester may be use directly and it may be used to charge a capacitor or a rechargeable battery 1047. Alternatively, a primary cell battery may be switched in when harvested energy is inadequate for demand.

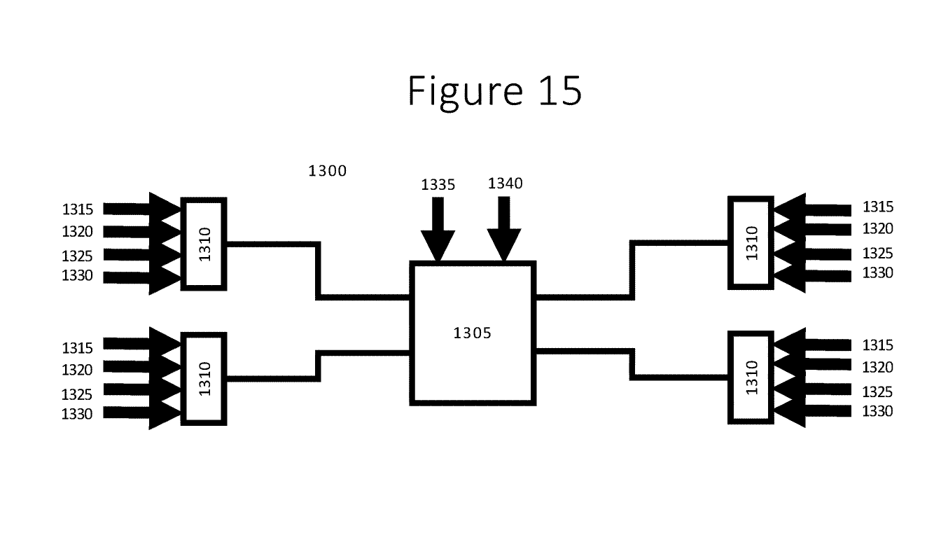

Referring now to FIG. 15, a monitoring system 1300 includes a controller 1305 and from a plurality of transmitters 1310, such as between 1 and 4 transmitters 1310, with one transmitter 1310 for each cylinder. Each transmitter typically transfers measured cylinder head end pressure 1315, crank end pressure 1320, suction temperature 1325 and temperature at other locations, and crosshead vibration 1330. The controller 1305 receives electric power 1335 from one or more harvesting generator systems as described herein, preferably including a battery backup or another power source. The controller 1305 also tracks top dead center (TDC) 1340 and degree angle from powered or self-powered devices connected to the reciprocating machine.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A system for monitoring operation of a reciprocating compressor, the system comprising: an inductive power generator configured such that cyclic motion of a component of the compressor causes at least one magnet to move with respect to at least one coil and thereby inductively generate electrical power and one or more sensors powered by cyclic motion of the compressor for monitoring a condition of the reciprocating compressor.

2. The system for monitoring operation of a reciprocating compressor of claim 1, further comprising a generator rotor coupled to a shaft of the compressor, the generator rotor including one or more permanent magnets.

3. The system for monitoring operation of a reciprocating compressor of claim 1, further comprising one or more stationary magnetic pickups located in proximity to the generator rotor, wherein movement of the generator rotor in relation to the stationary magnetic pickups generates electrical power for the one or more sensors.

4. The system for monitoring operation of a reciprocating compressor of claim 3, wherein a top dead center (TDC) position of the reciprocating compressor is measured based on a magnet located on the generator rotor.

5. The system for monitoring operation of a reciprocating compressor of claim 1, wherein a device powered by cyclic motion of the compressor monitor conditions selected from the group consisting of: top dead center detection, encoder angle of rotation measurement, cylinder head end pressure measurement, crank end pressure measurement, suction temperature measurement, additional cylinder temperature measurement, crosshead vibration measurement, monitor controller operation, and wireless communication with a monitor.

6. A system for monitoring operation of a reciprocating compressor, the system comprising an inductive power generator coupled to a shaft of the reciprocating compressor and one or more sensors in electrical communication with the inductive power generator for powering the one or more sensors, wherein sensors powered by reciprocal motion of the compressor monitor conditions selected from the group consisting of: top dead center detection, encoder angle of rotation measurement, cylinder head end pressure measurement, crank end pressure measurement, suction temperature measurement, additional cylinder temperature measurement, crosshead vibration measurement, monitor controller operation, and wireless communication with a monitor.
